(19) United States
(12) Patent Application Publication
(10) Pub. No.: US 2011/0197206 A1
(43) Pub. Date: Aug. 11, 2011

(54) System, Method And Program Product For Analyses Based On Agent-Customer Interactions And Concurrent System Activity By Agents

(75) Inventors: Om D. Deshmukh, New Delhi (IN); Chitra Dorai, Chappaqua, NY (US); Maureen E. Rzasa, Phoenix, AZ (US); Shailesh Joshi, New Milford, CT (US); Ashish Verma, New Delhi (IN); Karthik Visweswariah, Banagalore (IN); Gary J. Wright, Henderson, NV (US); Sai Zeng, Elmsford, NY (US)

(73) Assignee: International Business Machines Corporation, Armonk, NY (US)

(21) Appl. No.: 12/704,002

(22) Filed: Feb. 11, 2010

(51) Int. Cl. G06F 9/44

(52) U.S. Cl. 719/317

(57) ABSTRACT

A method includes deriving first information from a number of agent-customer interactions in a customer service system, and determining concurrent system activity by the agents in the customer service system, the concurrent system activity occurring at least partially concurrently with the number of agent-customer interactions. The method further includes combining the determined first information and the determined concurrent system activity to determine second information related to one or more of the number of agent-customer interactions, and outputting the second information. Apparatus and program products are also disclosed.

### BACKGROUND

This invention relates generally to techniques for processing agent-customer interactions and, more specifically, relates to determining information from the interactions and concurrent agent activity.

Call centers are part of a customer service system, both of which are included under the strategy of customer relationship management (CRM). Call centers handle a variety of topics, from customer support to technical support to billing. Interactions between the agents who respond to the calls (or the chats) can be complex. There have been studies in the past that analyzed these interactions to attempt to provide insight and feedback, and therefore improve efficiency, customer loyalty, and revenue.

For instance, a contact study has been used to assess call center and back office operations in delivery centers. The contact study was performed by using a “contact collector tool”, which is an advanced “time and motion” tool that allows for capture and analysis of existing agent contact handling interactions, processes and behaviors. The contact study helped leading companies identify key areas for improvement, including providing data for business case justification to support the overall business vision and leverage the contact center as a competitive differentiator. The contact study provided a mechanism to derive operational strengths and areas for opportunity.

To perform the contact study, people were sent to sit side-by-side with agents to use the contact collector tool to collect information such as segmentations of call handling, information technology (IT) system utilization and business related information. Once such data was collected, analysts have to consolidate individual input to perform analysis. Overall, this particular contact study took about 320 human hours per engagement.

While the results of the contact study were very useful, the contact study used a tremendous number of human hours. It would be beneficial to provide techniques that do not require such a large human hour requirement.

### SUMMARY

In a first aspect, a method includes deriving first information from a number of agent-customer interactions in a customer service system, and determining concurrent system activity by the agents in the customer service system, the concurrent system activity occurring at least partially concurrently with the number of agent-customer interactions. The method further includes combining the determined first information and the determined concurrent system activity to determine second information related to one or more of the number of agent-customer interactions, and outputting the second information.

In a second aspect, an apparatus is disclosed that includes one or more processors and one or more memories coupled to the one or more processors and comprising program code. The one or more processors, in response to executing the program code, are configured to cause the apparatus perform the following: deriving first information from a number of agent-customer interactions in a customer service system; determining concurrent system activity by the agents in the customer service system, the concurrent system activity occurring at least partially concurrently with the number of agent-customer interactions; combining the determined first information and the determined concurrent system activity to determine second information related to one or more of the number of agent-customer interactions; and outputting the second information.

In a third aspect, a computer readable medium is disclosed that tangibly embodies a program of machine-readable instructions executable by a digital processing apparatus to cause the digital processing apparatus to perform operations including: deriving first information from a number of agent-customer interactions in a customer service system, and determining concurrent system activity by the agents in the customer service system, the concurrent system activity occurring at least partially concurrently with the number of agent-customer interactions; combining the determined first information and the determined concurrent system activity to determine second information related to one or more of the number of agent-customer interactions; and outputting the second information.

### BRIEF DESCRIPTION OF THE SEVERAL VIEWS OF THE DRAWINGS

The foregoing and other aspects of embodiments of this invention are made more evident in the following Detailed Description of Exemplary Embodiments, when read in conjunction with the attached Drawing Figures, wherein:

FIG. 1, including both FIGS. 1A and 1B, is a flow diagram of actions that occur using customer relationship management (CRM) system using an exemplary embodiment of the invention;

FIG. 2 is an example of a depiction of an agent-customer interaction showing call phases and system activity;

FIG. 3 is an example of an exemplary system suitable for use with the instant invention;

FIG. 4 is a block diagram of an exemplary overview of a system (and method) for implementing an exemplary embodiment of the instant invention;

FIG. 5 is a block diagram of an exemplary system and method for the speaker turn detection block shown in FIG. 4;

FIG. 6 is a block diagram of an exemplary system and method for the call/chat segmentation block shown in FIG. 4;

FIG. 7 is a block diagram of a graphical user interface (GUI) to identify calls that meet certain criteria;

FIG. 8 is a block diagram of a GUI to display insights derived from a specific set of calls;

FIG. 9 is a block diagram of a GUI to compare two sets of calls;

FIG. 10 is a block diagram of another exemplary system for implementing the instant invention;

FIG. 11 is a flowchart of a method of determining probability of each phase for multiple phases in one turn from a speaker;

FIGS. 12 and 13 are histograms comparing phase distribution in two types of calls, where FIG. 12 shows calls with resolution less than 50 words in a reference (about 10 percent of the calls), where FIG. 13 shows calls with resolution greater than or equal to 50 words in the reference (about 90 percent of the calls), and where the number of words in each of the phases is shown; and

FIG. 14 is a flowchart of a method for analyses based on agent-customer interactions and concurrent system activity, in accordance with an exemplary embodiment of the invention.

### DETAILED DESCRIPTION

Techniques are disclosed herein for multi-modal processing for automatic call/chat segmentation and analysis. These techniques can analyze speech/text (i.e., call/chat) agent-customer interactions coupled with concurrent system activity of the agents to derive insights that can improve the efficiency of the customer service process. Applications of these techniques include, but are not limited to agent performance analysis, process efficiency improvement, and automatic quality monitoring. Applications of these techniques provide analysis with a much lower human hour cost.

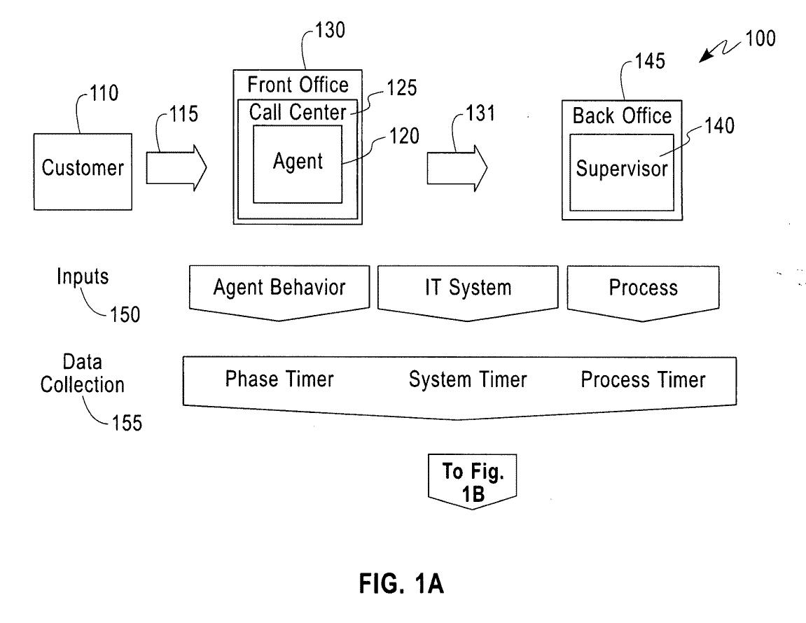

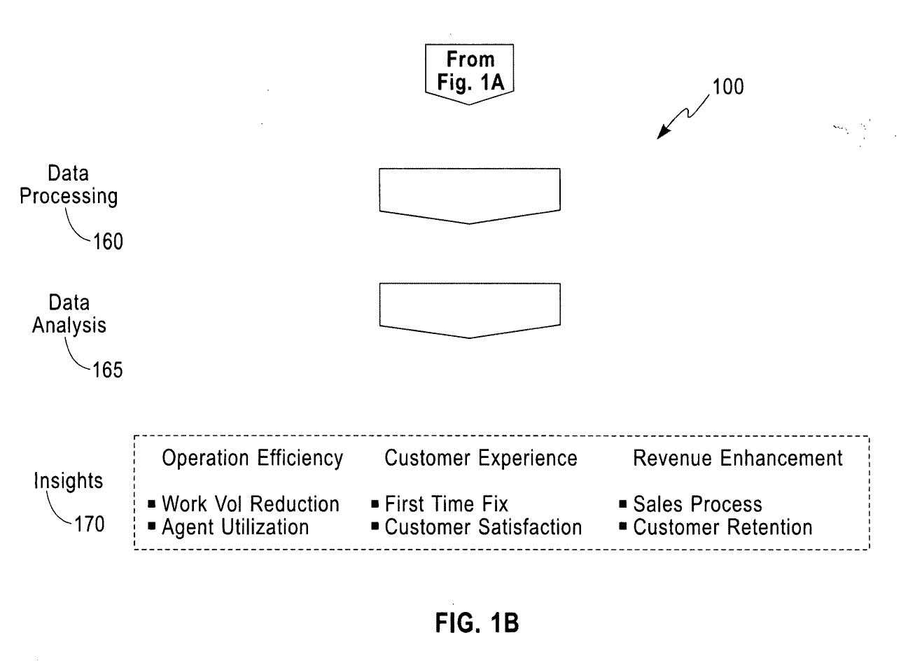

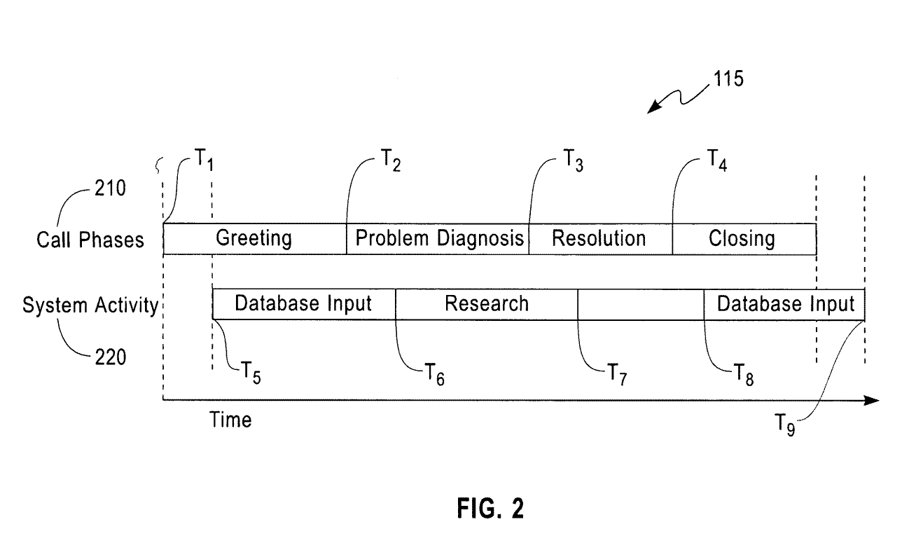

FIGS. 1 and 2 provide a brief overview of examples of the types of processing performed by the instant invention and what an example interaction between a customer and agent might look like.

Referring now to FIG. 1, including both FIGS. 1A and 1B, a flow diagram 100 is shown of actions that occur in a customer relationship management (CRM) system using an exemplary embodiment of the invention. Flow diagram 100 is a broad, non-limiting overview of actions that can occur. Customer 110 has an interaction 115 with an agent 120. The agent 120 is part of a call center 125 that performs support services. The call center 125 is part of the front office 130, a customer service system. The front office 130 has primary responsibility for customer service, such as technical support, billing support, and the like. There is also an interaction 131 between the front office 130 and the back office 145.

Associated with the back office 145 is a supervisor 140. The back office 145 has supervisory level of support, such as billing and oversight. From the front office 130 and the back office 145, the inputs 150 are used in the data collection 155 action. After data collection 155, there is data processing 160, data analysis 165, and insights 170. The instant invention resides primarily in the data processing 160 action, but also can perform at least some part of the data analysis 165 action.

A typical scenario would be that the supervisor 140 would like to be able to examine information about the interaction 115, in order to reach the insights 170. The data processing 160 and data analysis 165 provided by the instant invention can provide the types of exemplary insights 170.

Turning now to FIG. 2, an example is shown of a depiction of an agent-customer interaction 115 showing call phases 210 and system activity 220. This depiction is for illustrative purposes only and a real interaction 115 may look quite different. System activity 220 is a metric illustrating the interaction between the agent 120 and the computer system used by the agent 120. The call phases 210 include the “greeting”, “problem diagnoses”, “resolution”, and “closing” phases. The system activity 220 includes a first “database input”, “research”, and a second “database input” activities. This example concerns call phases, but chat phases operate similarly. A phase is a contiguous chunk of an interaction where predominantly only a single topic is discussed. Thus, during this interaction 115, there is some greeting that occurs between the customer 110 and the agent 120. During the greeting phase, the agent is also concurrently causing the system activity 220 of a database input. For example, the agent could be entering salient information about the customer, such as type of system, contact information, and the like. During the problem diagnosis phase, the agent continues to concurrently enter data into the database, and thus the database input system activity overlaps both the greeting phase and the problem diagnosis. Similarly, the research system activity overlaps the problem diagnosis and resolution phases. A research activity might occur after the agent 120 has enough information, e.g., to begin a search in a knowledge base, confer with coworkers or supervisors (which may or may not produce a system activity 220), search in other databases, and the like.

The instant invention can provide time locations T1, T2, T3, and T4 for the call phases. Furthermore, in order to determine the time locations T1-T4, the invention can use the time locations T5, T6, T7, T8, and T9 of the system activities 220 in order to provide more accurate assessments of the locations T1-T4. For instance, the system activity 220 between T6 and T7 indicates that the greeting phase is most likely concluded. Combining the system activity information 220 with information about the interaction 115 can therefore provide additional analysis and determination of the call phase information 210. Moreover, the instant invention can also be used (as a non-limiting, non-exhaustive list) to perform the following, which aid in insight: (a) understand what call phase is taking what proportion of the interaction time (this can be used to change the interaction style as an example); (b) detect calls that behave significantly different from an average call; and/or (c) detect calls that fit a certain criterion (for, e.g., calls with no “closing” phase).

Similar to the contact study previously described, the invention may also be used in a contact study. Such contact studies are often a part of CRM process transformation. A project goal of such a contact study includes enabling contact study automation with established bases, for visibility into front office 130 and back office 145 processes, and developing quantifiable insight for process improvements. Additional goals commensurate with this include:

1) Automate and simplify contact (call and case) study data collection with identification of phase and system timers for contact analysis;

2) Perform advanced analytics with the contact study data for process behavior insights leading to opportunities for process improvement; and

3) Track improvement opportunities identified by time volume capture (TVC) and automatic contact collector (ACC) tools together across sites and resource pools for higher productivity and standardization within processes. Such goals may be met by exemplary aspects of the instant invention.

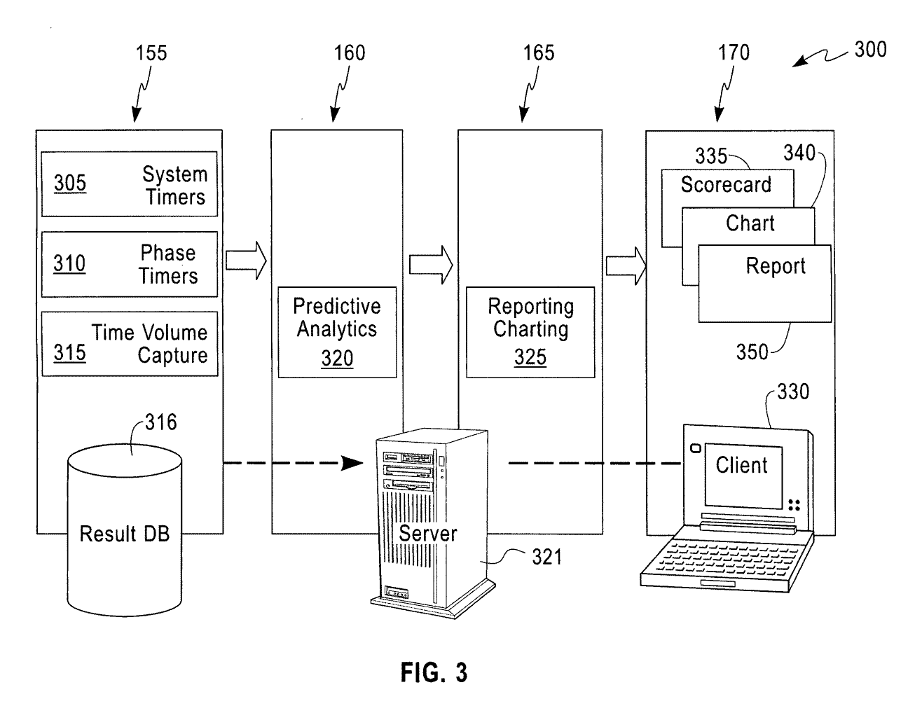

Referring now to FIG. 3, an example of an exemplary system 300 suitable for use with the instant invention. The system 300 represents an exemplary technical approach and platform for call/case data collection, metrics and process insights. The system 300 includes a data collection portion 155, a data processing portion 160, a data analysis portion 165, and an insights portion 170. The data collection portion 155 includes system timers 305, phase timers 310, and other established tools like the time volume capture 315. The system timers are also shown in FIG. 1A. The phase timers 310 are one way of gauging agent behavior. The data collection 155 is stored on a result database 316. The data processing portion 160 includes predictive analytics 320, and the data analysis portion 165 includes reporting/charting tool(s) 325. The server 321 typically performs the data processing portion 160 and the data analysis portion 165.

The insights portion 170 is typically displayed by the client computer 330, although the reporting/charting tool(s) 325 provides data to the client computer 330. The client computer 330 is showing output of the reporting/charting tool(s) 325 and shows a scorecard 335 (e.g., how well certain criteria are being met), a chart 340, and a report 350.

Typically, the front office 130 is that section of the contact center that deals with the customers at real-time, i.e., voice calls or interactive chats. The back office 145 is the section which deals with non-real-time transactions like emails, letters, voice mails. However, the instant invention may take a wide variety of configurations. The scorecard 335, chart 340, report 350 all help to develop insight, such as to understand what call phase is taking what proportion of the interaction time, to detect calls that behave significantly different from an average call, and/or to detect calls that fit a certain criterion. The instant invention has aspects spread across all of the data collection portion 155, data processing portion 160, data analysis portion 165, and insights portion 170. The system 300 will typically be used to understand the interaction process at an aggregate level (i.e., across various agent and different times) by an expert (e.g., supervisor 140) whose goal is typically to find out ways in which the process can be made more efficient (i.e., spend less time and/or improve rate of problem resolution and/or improve customer satisfaction) and/or find out areas of improvement for individual agents. Example insights are mentioned above. The insights should give an idea on what kind of questions can be asked. For example, (a) what was the agent doing when the customer was on hold, (b) what was the main concern of the customer? Other exemplary insights include (a) the time spent in the problem diagnosis phase (a phase 210 of FIG. 2) is on an average more for calls that resolved the customer's problem as compared to calls that didn't resolve the problem, (b) agents who keep “notepads” handy to avoid asking the same question multiple times have better problem diagnosis and resolution phases (phases 210 of FIG. 2), and (c) the hold time was high for a specific agent because the agent has poor typing skills.

The instant invention, e.g., using the system 300 or portions thereof may be used to improve the efficiency of call/chat processes by combining (a) insights obtained from the audio exchange of the call, and (b) concurrent activities on the agent's computer system. Further, exemplary embodiments of the instant invention provide methods, apparatus, and program products for segmenting conversations that use multiple sources of information, including system activity, transcription of audio, identity of speakers (e.g., caller/agent), and prosodic features and that use an automatic or semi-supervised learning algorithm to make the most efficient use of available labeled training data. Exemplary embodiments of the instant invention are also directed to techniques for determining identity of speaker that uses acoustic, lexical, automatic speech recognition (ASR)-related and channel-specific features. Additional exemplary embodiments provide techniques for answering higher level questions about calls that use segments of the conversation along with other features including: words transcribed, emotions and information aggregated across calls.

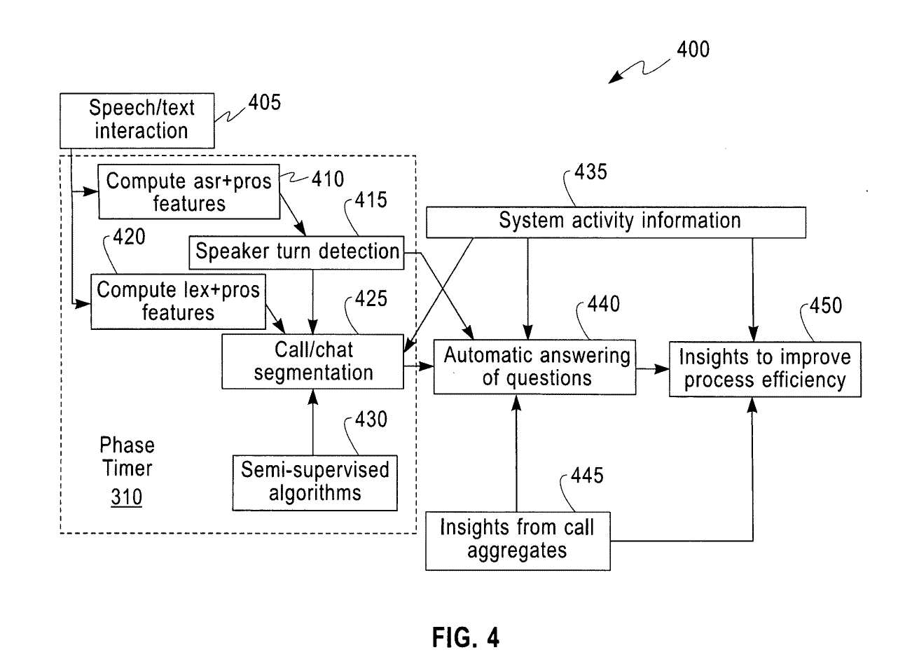

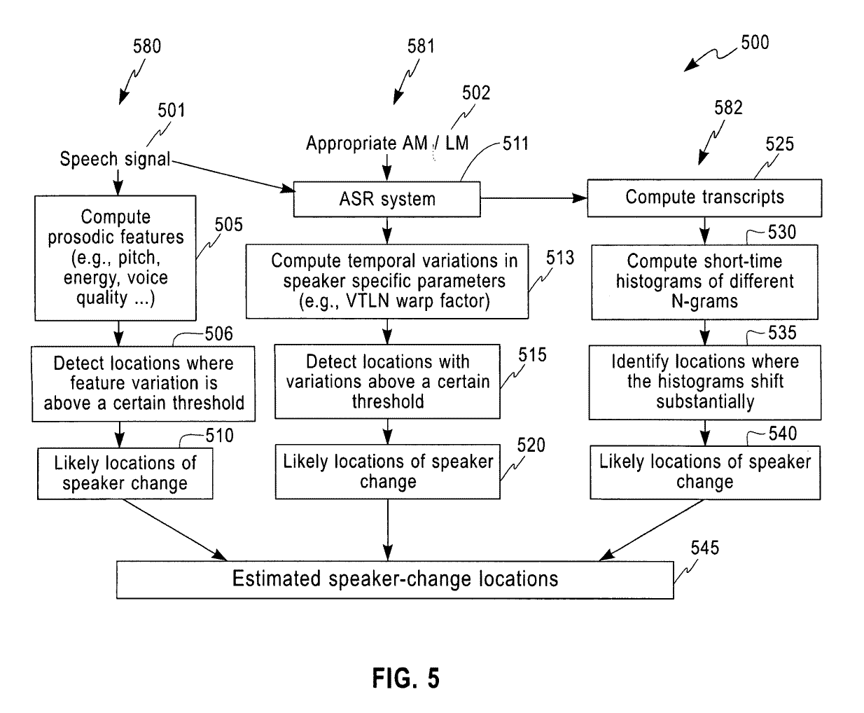

Referring now to FIG. 4, a block diagram is shown of an exemplary overview of a system (and method) for implementing an exemplary embodiment of the instant invention. Although system 400 is described herein as implementing certain of the blocks shown in FIG. 4, certain of the blocks may also be actions performed by a method or program product. Phase timer 310 of FIG. 3 is formed by blocks 410, 415, 420, 425, and 430. System timers 305 provide input to the system activity information 435. The system timers 305 are equivalent in this example to the system activity information 435. Speech/text interaction(s) 405 are analyzed by block 410, where automatic speech recognition (ASR) is performed and prosodic (pros) features are determined. Speaker turn detection is performed in block 415 (see FIG. 5).

Semi-supervised algorithms are performed in block 430. These algorithms 430 make optimal use of the limited hand labeled audio calls to generate phase boundaries and/or other labels for unlabeled calls and use these labels to re-learn the characteristics of the interactions. One possible embodiment of a semi-supervised algorithm 430 is described as follows. A Hidden Markov Model (HMM) model can be trained on the unlabelled data (which are, e.g., the ASR transcripts of the audio calls with no information about the phase/segment boundaries). The trained HMM model will assign a “phase label” to each part of the call-transcript. This phase label can then be used as an additional feature in the supervised training procedure on the labeled data. Another way of utilizing the trained HMM model is to use the output of the HMM model to find the words/features that are highly correlated with certain HMM states and then assign a higher weight to these words/features in the supervised training.

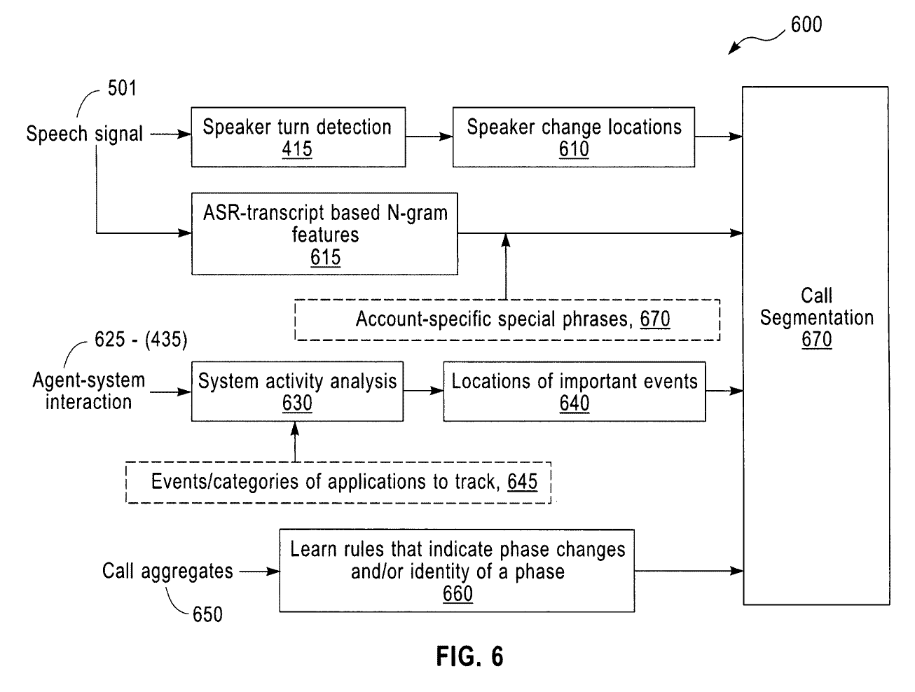

Speech/text interaction(s) 405 are analyzed by block 420, which computes lexicon and prosodic (pros) features. Call/chat segmentation is performed in block 425 (see FIG. 6).

In block 440, the system 400 may perform automatic answering of questions based on inputs from blocks 415 and 425, and from system activity information 435 and insights from call aggregates 445. Insights from call aggregates 445 are generated by aggregating the calls that are similar on some dimensions such as “on same topic”, “from close geographical location” or “around the same time” and so on. Insights can include “average proportion of each of the phases”, “most likely sequence of phases”, “tools/aids available to the agent” and so on. It is noted that block 440 can benefit from analysis of similar calls, such as calls occurring around the same time or from a geographically close area or on the same topic. Such global analysis captures dynamically varying trends. In block 450, insights to improve process efficiency are determined.

With regard to the system activity information block 435, customer-agent interaction typically involves a parallel interaction between the agent and the system, e.g., retrieving/verifying customer data, browsing frequently asked questions (FAQs), generating requests and so on. In response to this, temporal profiles of various activities of the agent are generated on the system (using, e.g., system times 305). Many high-level questions (e.g., ‘what did the agent do while the customer was on hold?” and so on) can be answered only by combining such system activity profiles with insights from audio data. System activity information also helps in improving the performance of call segmentation (block 425).

In regard to the automatic answering of questions block 440, the following observations may be made: (1) answers for questions are not equally likely in each phase 210; (2) some answers are more likely in speech of the agent (or speech of the customer); and (3) emotions are indicative of many answers. Consequently, to learn likely answer phrases, calls are analyzed where the answers are provided by human experts and the locations of the answers are hand-labeled. This analysis occurs in semi-supervised algorithms block 430 and also in insights from call aggregates block 445. The hand-labels from the experts are learnt from semi-supervised algorithms block 430 and the call trends are captured in insights from call aggregates block 445. Additionally, the call/chat segmentation block 425 is the segmentation phase, which has the information that can be used by the automatic answering of questions block 440.

Turning to FIG. 5, a block diagram is shown of an exemplary system and method (and program product) for the speaker turn detection block 415 shown in FIG. 4. Assuming FIG. 5 can be viewed as three vertical “towers”, the left most tower is the “prosodic features” tower 580, the middle tower is the “ASR features” tower 581 and the right tower is the “lexicon features” tower 582. The compute ASR and prosodic features block 410 is a combination of the middle tower 581 and left tower 582, and the compute lexicon and prosodic features block 420 is a combination of the right tower 580 and the middle tower 581.

Concerning ASR-based features, the speaker independent ASR system, with appropriate AM/LM (acoustic model/language model) 502, periodically computes speaker-specific parameters (SSPs) (e.g., VTLN α-factor) to improve the recognition performance. VTLN is vocal tract length normalization, and “VTLN α-factor” is a technical term used in ASR algorithms to recognize the speech even when the speaker changes. If there is a significant change in one or more of these SSPs, this indicates a change in speaker. Also, for regions with similar values for all the SSPs, this indicates speech is from the same speaker. The ASR system 511 uses the appropriate AM/LM (acoustic model/language model) 502 and the speech signal 501. In block 513, temporal variations in speaker specific parameters (e.g., VTLN warp factor, also called the VTLN α-factor herein). In block 515, locations are detected with variations above a certain threshold. In block 520, likely locations of speaker change are determined.

With regard to prosodic features, each speaker has a unique speech production apparatus. This uniqueness is captured by analyzing the physical speech signal 501. In block 505 therefore, prosodic features such as pitch, energy, and voice quality are computed. In block 506, locations are detected where feature variation is above a certain threshold. In block 510, likely locations of speaker changes are determined.

Concerning lexical features, typically, different sets of words are spoken by the customer and the agent during different phases of the interaction. In order to determine these different sets, transcripts are computed in block 525. In block 530, short-time histograms of different N-grams are computed. In block 535, locations are identified where the histograms shift substantially. In block 540, likely locations of speaker change are determined.

It is noted that the ASR and or the prosodic features can also include channel-specific features may also be used. The volume, background noise and other non-speech cues vary across the customer and the agent location.

Combination of the above features in block 545 leads to a temporal profile of silence/speaker-turn and locations of speaker changes.

Turning now to FIG. 6, a block diagram is shown of an exemplary system 600 and method (and program product) for the call/chat segmentation block 425 shown in FIG. 4. FIG. 6 is in some sense a more detailed version of the processing until the call/chat segmentation block 425 of FIG. 4. The compute lexicon and prosodic features block 420 is included as blocks 615 and 620 of FIG. 6. The example of FIG. 6 is primarily focused on telephone calls, but similar techniques may be used for chat. The speech related processing (speaker-turn detection, automatic speech recognition) will not be needed in chat (which is typically a text-based exchange) processing. Speaker turn and emotion information are used to detect phase boundaries. But, it is possible that phases overlap in one turn. Typically, prosodic cues indicate when the topic is changed even when the same speaker is speaking. Techniques herein analyze the prosodic and lexical content of each speaker turn in combination with the system activity information and can assign each turn to multiple phases with different probabilities.

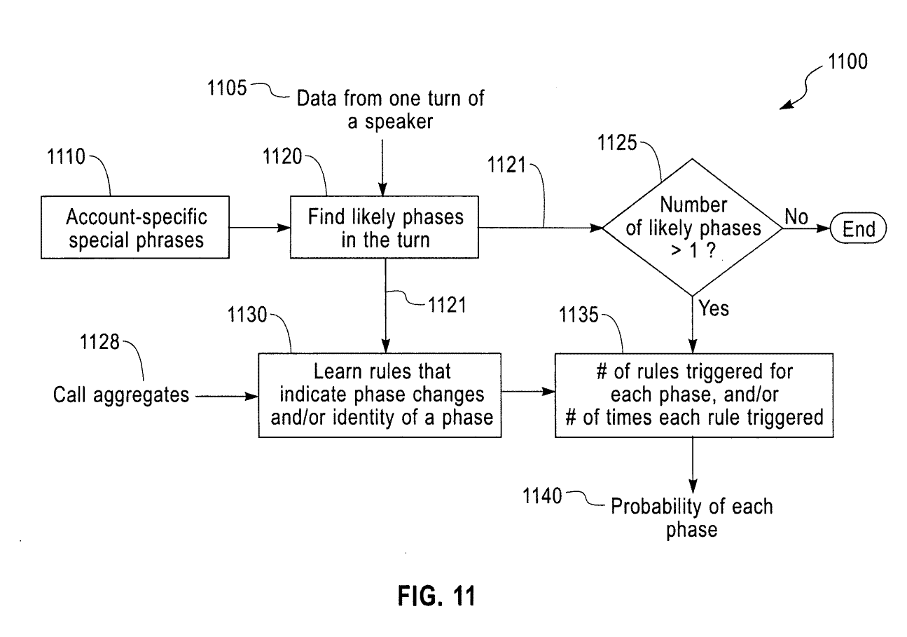

For instance, FIG. 11 is a flowchart of a method 1100 of determining probability of each phase for multiple phases in one turn from a speaker. Data from one turn of a speaker 1105 and account-specific special phrases 1110 are input to block 1120, which finds likely phases in the turn. Call aggregates 1128 and output 1121 from block 1120 are input into bloc 1130, which learns rules that indicate phase changes and/or identity of a phase. In block 1125, it is determined if the number of likely phases is greater than one. If not, the method would end. If so, in block 1135, the number (#) of rules triggered for each phase and/or the number of times each rule is triggered is determined. From this, the probability 1140 of each phase is determined. As the number of rules triggered for each phase increases for a particular phase, a higher probability would be assigned to that phase as compared to phases triggering fewer rules. Similarly, as the number of times a rule is triggered increases, a higher probability would be assigned to that phase as compared to phases the rule fewer times.

The speaker turn information 415 (see FIGS. 4 and 5) produces speaker change locations 610. In block 615, the speech signal 501 is analyzed to create N-gram features based on ASR transcripts. It is also noted that account-specific special phrases from block 620 may be input at this point. For example, an account supporting computer systems will have different terminology from an account supporting some other technology.

Agent-system interaction 625 is input to block 630. The agent-system interaction 625 is the system activity information 435. In block 630, system activity analysis is performed, and locations of important events are determined in block 640. It is noted that the system activity analysis in block 630 may be supplemented and helped by events/categories of applications to track (block 645). Some examples of events/categories-of-applications to track are “agent filling the problem escalation form”, “agent browsing FAQ pages”, “agent accessing the client's servers for information” and so on.

In block 660, call aggregates 650 are analyzed to learn rules that indicate phase changes and/or identity of a phase. One way of learning the rules mentioned in 660 is to analyze the distribution of words in the vicinity of phase boundaries and in the middle of the phases.

In block 670, these various outputs are combined in order to segment calls. A phase is identified for segmentation at locations where multiple of the following sources identify a trigger: (a) speaker change is identified, (b) account-specific or N-gram based feature is detected, (c) system activity indicates an event of interest, (d) a phase-change or phase-ID rule is triggered.

Each of the above modes provides complementary information. For example, (a) audio analysis can indicate the location of hold and who initiated the hold, (b) the corresponding system information can indicate what happened during the hold, and (c) speaker identification (ID) detection after the hold can identify if a new agent (i.e., a subject matter expert) joined the interaction. Combining this information captured by different modes gives a richer understanding of the interaction. Blocks 670 and 450 are the block where this combination of information from different modes is performed.

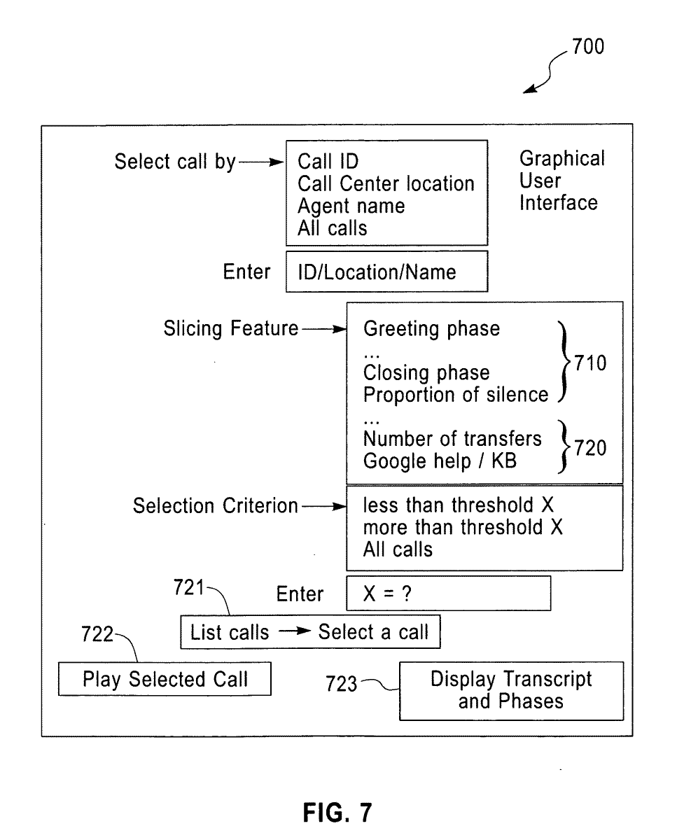

Referring now to FIG. 7, a block diagram is shown of a graphical user interface (GUI) 720 to identify calls that meet certain criteria. The GUI 700 would be used by, e.g., supervisor 140 in order to analyze information about incoming calls (and chats) and to determine insights. As shown in FIG. 3, the GUI 700 would typically be displayed on a client computer 330 that accesses a server 321. The GUI 700 allows calls to be selected, e.g., by call identification (ID), call center location, agent name, or all calls. The “Enter” block also allows hand-typed entry. The GUI 700 provides and allows selection of a slicing feature, some of which are related to the calls (indicated by reference 710) and some of which are related to system activity (indicated by reference 720). For instance, phases 210 such as the greeting phase and the closing phase may be selected. The amount and locations of time spent in Google help or in a knowledgebase (KB) may be selected.

A selection criterion may also be selected or entered (in the Enter block with “X=?”). The button 721 allows one to list calls and then to select a call. The button 722 allows a selected call to be played. The button 723 allows a transcript and phrases to be displayed.

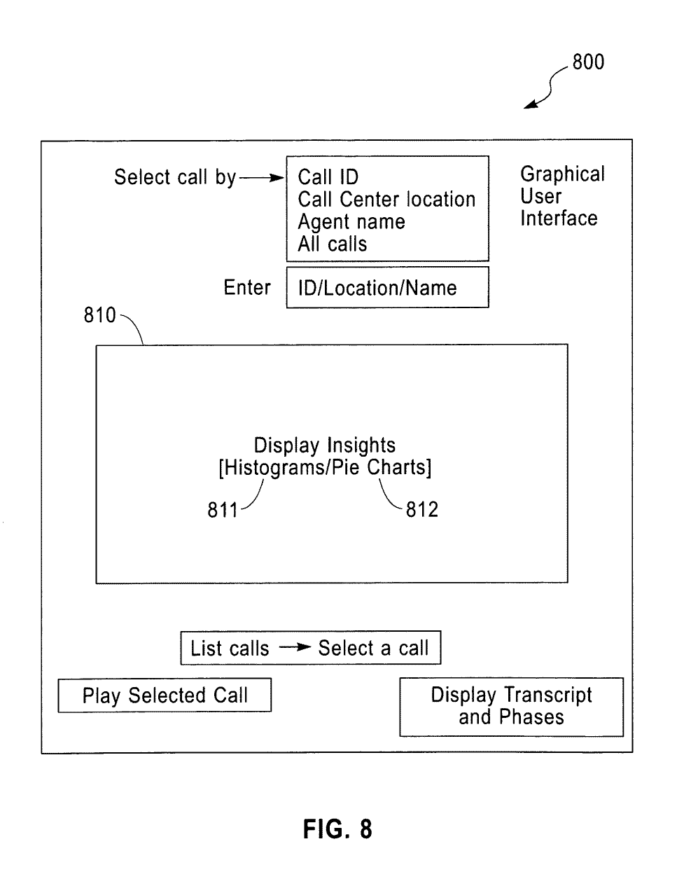

FIG. 8 is a block diagram of a GUI 800 to display insights derived from a specific set of calls. GUI 800 is similar to GUI 700 and only differences are described herein. In block 810, insights would be displayed. Such insights include histograms 811 or pie charts 812 and may also include scorecards 335, charts 340, and reports 350 (see FIG. 2). The block 810 is directed to a specific set of calls.

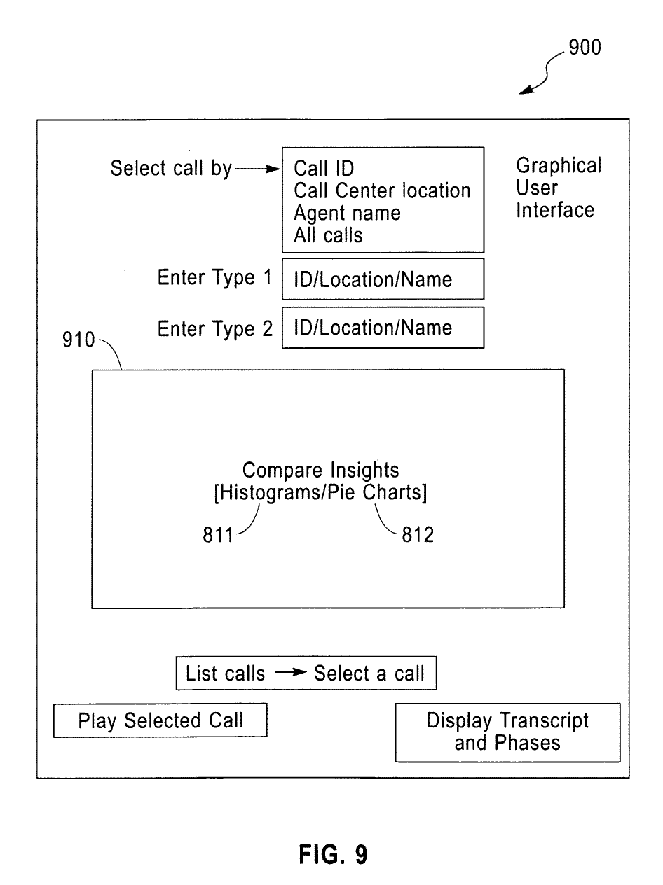

FIG. 9 is a block diagram of a GUI to compare two sets of calls. In this example, the block 810 for a specific set of calls has been replaced by block 910, for a comparison of two sets of calls.

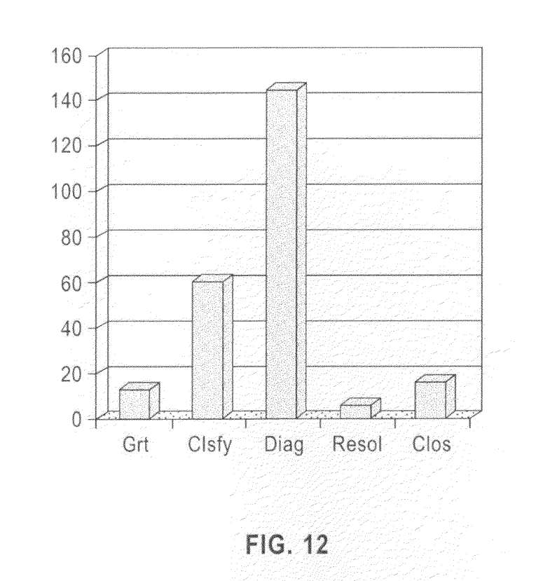

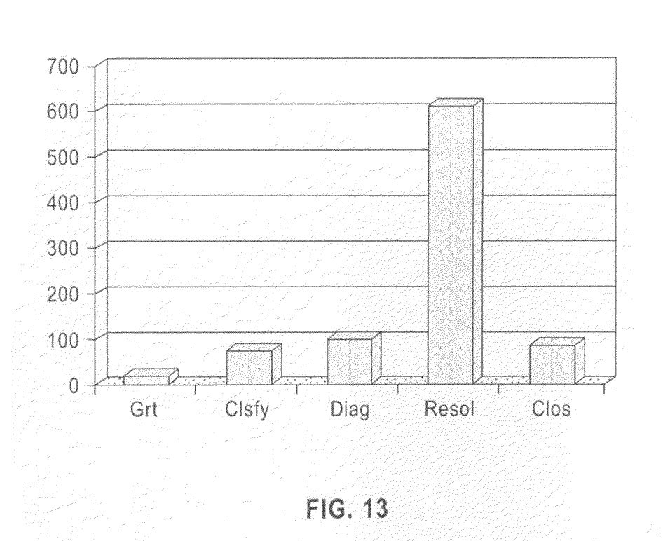

FIGS. 12 and 13 illustrate examples of types of histograms 811 that can be provided by the GUIs 800/900. FIGS. 12 and 13 are histograms comparing phase distribution in two types of calls. FIG. 12 shows calls with resolution less than 50 words in a reference (about 10 percent of the calls). FIG. 13 shows calls with resolution greater than or equal to 50 words in the reference (about 90 percent of the calls). The number of words in each of the phases is shown. In this case, there is a greeting (Grt) phase, a classify (Clsfy) phase, a problem diagnosis (Diag) phase, a resolution (Resol) phase, and a closing (Clos) phase.

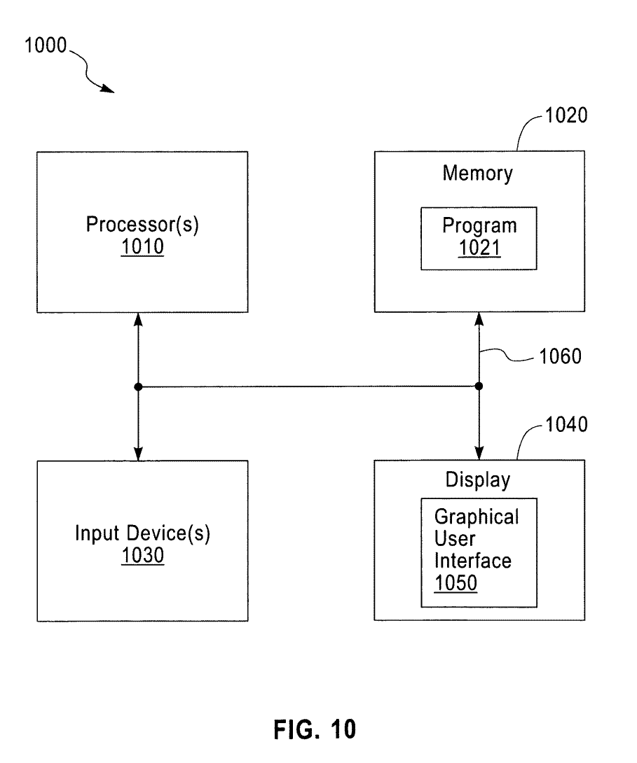

FIG. 10 is a block diagram of another exemplary system 1000 for implementing the instant invention. System 1000 includes one or more processors 1010, one or more memories 1020, one or more input devices 1030, a display 1040, and one or more buses 1060. The memory 1020 includes a program 1021 having program code. The memory 1020 is therefore a computer readable medium having program code embodied thereon. In this example, the display 1040 shows a GUI 1050. This system may also be distributed, as shown in FIG. 3, where server 321 handles certain functions, and client computer 330 displays the GUI 1050. Each of the server 321 and client 330 would have at least one or more processors 1010, one or more memories 1020, and one or more buses 1060.

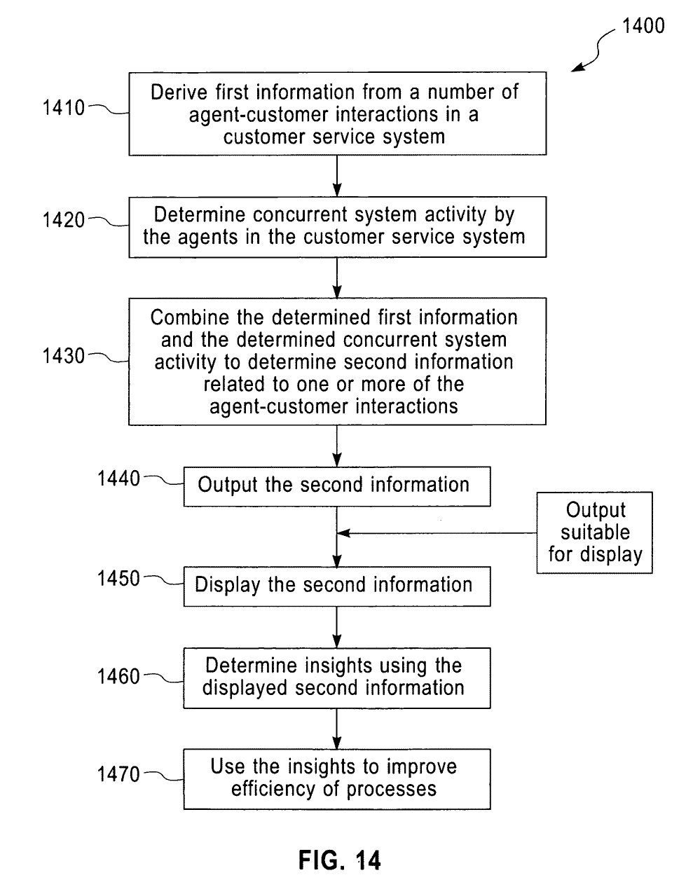

Turning to FIG. 14, FIG. 14 is a flowchart of a method 1400 for analyses based on agent-customer interactions and concurrent system activity, in accordance with an exemplary embodiment of the invention. It is also noted that the actions taken in method 1400 may also be performed by an apparatus or by a program product. Method 1400 begins in block 1410, when first information is derived from a plurality of agent-customer interactions in a customer service system. Deriving such first information includes, e.g., the following: segmentation described above in reference to FIGS. 4 to 6, including deriving speaker turn information (see FIG. 5 and associated text) and assigning probability of each phase for multiple phases in one turn from a speaker (see FIG. 11 and associated text); use of hand-marked phase (see 430 in FIG. 4 and associated discussion); deriving prosodic features, lexical features, automatic speech recognition-based features, and channel-specific features (see FIGS. 4-6 and associated text); and combinations of these.

In block 1420, concurrent system activity is determined (see, e.g., blocks 435, 635). The concurrent system activity occurs concurrently with the agent-customer interactions. In block 1430, the determined first information and the determined concurrent system activity are combined to determine second information related to one or more of the agent-customer interactions. The second information is output (block 1440), e.g., in a form suitable for use for display. The second information is displayed in block 1450. Such display could be, e.g., the scorecard 335, chart 340, or report 340 in FIG. 3, the histograms 811 or pie charts 812 in FIGS. 8 and 9, and the histograms shown in FIGS. 12 and 13.

In block 1460, insights are determined using the displayed information. Insights have been described above but include (a) understanding what call phase is taking what proportion of the interaction time (this can be used to change the interaction style as an example); (b) detecting calls that behave significantly different from an average call; (c) detecting calls that fit a certain criterion (for, e.g., calls with no “closing” phase); (d) determining that the time spent in the problem diagnosis phase (a phase 210 of FIG. 2) is on an average more for calls that resolved the customer's problem as compared to calls that didn't resolve the problem; (e) determining that agents who keep “notepads” handy to avoid asking the same question multiple times have better problem diagnosis and resolution phases (phases 210 of FIG. 2); and (t) determining that the hold time was high for a specific agent because the agent has poor typing skills. In block 1470, the insights are used to improve the efficiency of process, such as performing agent performance analysis, process efficiency improvement, and automatic quality monitoring.

As should be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” It is noted that “entirely software” embodiments still require some type of hardware (e.g., a general purpose computer) on which to be executed (and therefore create a special purpose computer performing one or more of the actions described herein). Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or assembly language or similar programming languages. Such computer program code may also include code for field-programmable gate arrays, such as VHDL (Very-high-speed integrated circuit Hardware Description Language).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable digital processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable digital processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The foregoing description has provided by way of exemplary and non-limiting examples a full and informative description of the best techniques presently contemplated by the inventors for carrying out embodiments of the invention. However, various modifications and adaptations may become apparent to those skilled in the relevant arts in view of the foregoing description, when read in conjunction with the accompanying drawings and the appended claims. All such and similar modifications of the teachings of this invention will still fall within the scope of this invention.

Furthermore, some of the features of exemplary embodiments of this invention could be used to advantage without the corresponding use of other features. As such, the foregoing description should be considered as merely illustrative of the principles of embodiments of the present invention, and not in limitation thereof.

What is claimed is:

1. A method, comprising:
deriving first information from a plurality of agent-customer interactions in a customer service system;
determining concurrent system activity by the agents in the customer service system, the concurrent system activity occurring at least partially concurrently with the plurality of agent-customer interactions;
combining the determined first information and the determined concurrent system activity to determine second information related to at least one of the plurality of agent-customer interactions; and
outputting the second information.

2. The method of claim 1, wherein deriving first information further comprises performing segmentation on at least one of calls or chats to derive a plurality of phases associated with the at least one of the calls or chats.

3. The method of claim 2, wherein deriving first information further comprises performing segmentation on calls and deriving speaker turn information, the speaker turn information indicating which speaker of the agent or the customer was speaking during a particular time period.

4. The method of claim 3, wherein performing segmentation further comprises assigning a turn taken by one of the agent or customer and associated with an agent-customer interaction to multiple phases with different probabilities.

5. The method of claim 2, wherein performing segmentation further comprises using information from data that is hand marked as to phase in order to perform segmentation on the at least one of calls or chats to determine the plurality of phases.

6. The method of claim 5, wherein determining second information further comprises determining the second information using information from call aggregates.

7. The method of claim 5, wherein determining second information further comprises combining likely answer phrases with the segmentation, the concurrent system activity, and the information from call aggregates in order to provide at least one answer to at least one question input by a user, the at least one answer being second information.

8. The method of claim 5, wherein deriving first information further comprises performing segmentation on calls and deriving speaker turn information, the speaker turn information indicating which speaker of the agent or the customer was speaking during a particular time period.

9. The method of claim 8, wherein deriving the first information further comprises deriving prosodic features, lexical features, automatic speech recognition-based features, and channel-specific features.

10. The method of claim 1, wherein outputting the second information further comprises outputting data suitable for displaying the second information in at least one of a scorecard, chart, report, histogram, or pie chart.

11. The method of claim 10, further comprising displaying the at least one of the scorecard, chart, report, histogram, or pie chart.

12. The method of claim 1, wherein the first information comprises call type and call phases and the concurrent system activity comprises form filling, reading frequently asked questions, and performing research.

13. An apparatus comprising:
at least one processor;
at least one memory coupled to the at least one processor and comprising program code,
the at least one processor, in response to executing the program code, configured to cause the apparatus to perform the following:
deriving first information derived from a plurality of agent-customer interactions in a customer service system;
determining concurrent system activity by the agents in the customer service system, the concurrent system activity occurring at least partially concurrently with the plurality of agent-customer interactions;
combining the determined first information and the determined concurrent system activity to determine second information related to at least one of the plurality of agent-customer interactions; and
outputting the second information.

14. The apparatus of claim 13, wherein deriving first information further comprises performing segmentation on at least one of calls or chats to derive a plurality of phases associated with the at least one of the calls or chats.

15. The apparatus of claim 14, wherein deriving first information further comprises performing segmentation on calls and deriving speaker turn information, the speaker turn information indicating which speaker of the agent or the customer was speaking during a particular time period.

16. The apparatus of claim 15, wherein performing segmentation further comprises assigning a turn taken by one of the agent or customer and associated with an agent-customer interaction to multiple phases with different probabilities.

17. The apparatus of claim 14, wherein performing segmentation further comprises using information from data that is hand marked as to phase in order to perform segmentation on the at least one of calls or chats to determine the plurality of phases.

18. The apparatus of claim 17, wherein determining second information further comprises determining the second information using information from call aggregates.

19. The apparatus of claim 17, wherein determining second information further comprises combining likely answer phrases with the segmentation, the concurrent system activity, and the information from call aggregates in order to provide at least one answer to at least one question input by a user, the at least one answer being second information.

20. The apparatus of claim 17, wherein deriving first information further comprises performing segmentation on calls and deriving speaker turn information, the speaker turn information indicating which speaker of the agent or the customer was speaking during a particular time period.

21. The apparatus of claim 20, wherein deriving the first information further comprises deriving prosodic features, lexical features, automatic speech recognition-based features, and channel-specific features.

22. The apparatus of claim 13, wherein outputting the second information further comprises outputting data suitable for displaying the second information in at least one of a scorecard, chart, report, histogram, or pie chart.

23. The apparatus of claim 22, further comprising displaying the at least one of the scorecard, chart, report, histogram, or pie chart.

24. The apparatus of claim 13, wherein the first information comprises call type and call phases and the concurrent system activity comprises form filling, reading frequently asked questions, and performing research.

25. A computer readable medium tangibly embodying a program of machine-readable instructions executable by a digital processing apparatus to cause the digital processing apparatus to perform operations comprising:
deriving first information from a plurality of agent-customer interactions in a customer service system;
determining concurrent system activity by the agents in the customer service system, the concurrent system activity occurring at least partially concurrently with the plurality of agent-customer interactions;
combining the determined first information and the determined concurrent system activity to determine second information related to at least one of the plurality of agent-customer interactions; and
outputting the second information.
